(19) United States
(12) Patent Application Publication
(10) Pub. No.: US 2013/0166325 A1
(43) Pub. Date: Jun. 27, 2013

(54) APPARATUSES, SYSTEMS AND METHODS FOR INSURANCE QUOTING

(71) Applicants: Mohan Ganapathy, Cerritos, CA (US); Arun Arunachalam, Valencia, CA (US)

(72) Inventors: Mohan Ganapathy, Cerritos, CA (US); Arun Arunachalam, Valencia, CA (US)

(21) Appl. No.: 13/336,701

(22) Filed: Dec. 23, 2011

(51) Int. Cl. G06Q 40/08

(52) U.S. Cl. 705/4

(57) ABSTRACT

Apparatuses, systems and methods for insurance quoting are disclosed. One embodiment of the invention receives from a user one or more images related to a driver's license, which are generated by a portable electronic device. The method then extracts identification information from the received images, and generates an insurance quote based, at least in part, on the extracted identification information and presents the insurance quote to the user. The generated insurance quote may be a quote for an auto insurance, a home insurance, a flood insurance, a life insurance or the like.

### BACKGROUND OF THE INVENTION

1. Field of the Invention

This invention relates to apparatuses, systems, and methods for insurance quote and more particularly relates to obtaining and/or providing an insurance quote based on images which include identification information.

2. Description of the Related Art

With the rapid growth of e-commerce, getting an online insurance quote has become a service offered by most insurance companies in the United States. Nowadays, most common practices of online insurance quoting require a user to enter all the required information for a quote via an input device such as a keyboard. Quotes can be obtained either by an end customer, insurance agent or a call center representative.

The present invention discloses apparatuses, systems and methods for insurance quoting where the above mentioned process is made very efficient from an end user perspective. Rather than keying in all the data required to get an insurance quote, the disclosed invention allows a user to take a picture of a driver's license using any portable electronic device with a camera and send the images to a server. The sever extracts relevant information from the received images, generates an insurance quote based on extracted information, and sends back an insurance quote to the user.

### SUMMARY OF THE INVENTION

Embodiments of methods for insurance quoting are disclosed. One embodiment of the methods receives from a user one or more images related to a driver's license, which has been generated by a portable electronic device. The method also extracts identification information from the one or more images, generates an insurance quote based, at least in part, on the extracted identification information, and presents the insurance quote to the user. In one embodiment, the identification information includes a driver's license number, a name and a birth date of a driver, an address and zip code of a residence of a driver, a license plate of a vehicle, and/or a vehicle identification number (VIN) of a vehicle. In one embodiment, the generated insurance quote may be a quote for an auto insurance, a home insurance, a flood insurance, a life insurance, a health insurance, a dental insurance, or the like. In one embodiment, the method presents contact information of an agent to the user where the user can contact the agent for an insurance quote. In one embodiment, the method allows the user to purchase the insurance quote presented to him/her, e.g. through a web application hosted on a quote server.

One embodiment of the methods generates one or more images related to a driver's license using a portable electronic device, sends the one or more images to a server, where the server is configured to extract the identification information from the one or more images, and generates an insurance quote based, at least in part, on the extracted identification information. The method also receives the insurance quote from a server and presents the insurance quote to a user.

Apparatuses for insurance quoting are disclosed. One embodiment of the apparatuses is a portable electronic device. The portable electronic device includes a mechanism for generating one or more images including identification information, a transmitter to transmit the one or more images to a server, where the server is configured to extract the identification information from the one or more images, and to generate an insurance quote based, at least in part, on the extracted identification information. The portable electronic device also includes a receiver to receive the insurance quote, and a mechanism for presenting the insurance quote to a user.

One embodiment of the apparatuses includes means for receiving one or more images from a user, where at least one of the one or more images are related to a driver's license and generated by a portable electronic device. The apparatus further includes means for extracting the identification information from the one or more images, means for generating an insurance quote based, at least in part, on the extracted identification information, and means for transmitting the insurance quote to the user.

Systems for insurance quoting are disclosed. One embodiment of the systems includes a receiver configured to receive one or more images from a user, where the one or more images include identification information. The system further includes a server in data communication with the receiver, where the server is suitably configured to extract the identification information from the one or more images, and generate an insurance quote based, at least in part, on the extracted identification information. The system also includes a transmitter in data communication with the server, and suitably configured to transmit the insurance quote to a user.

The terms “a” and “an” are defined as one or more unless this disclosure explicitly requires otherwise.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram illustrating one embodiment of a system for insurance quoting.

FIG. 2 is a schematic block diagram illustrating one embodiment of a database system for insurance quoting.

FIG. 3A is a schematic block diagram illustrating one embodiment of an apparatus that may be used in accordance with certain embodiments of the system for insurance quoting.

FIG. 3B is a schematic diagram illustrating one embodiment of a portable electronic device that maybe used in accordance with certain embodiments of the system for insurance quoting.

FIG. 4 is a schematic logical diagram illustrating one embodiment of abstraction layers of operation in a system for insurance quoting.

FIG. 5 is a schematic block diagram illustrating one embodiment of a server for insurance quoting.

FIG. 6 is a schematic block diagram illustrating one embodiment of an identification card for insurance quoting.

FIG. 7 is a flow chart illustrating one embodiment of a method for insurance quoting.

FIG. 8 is a flow chart illustrating one embodiment of a method for insurance quoting.

FIG. 9 is a flow chart illustrating one embodiment of a method for insurance quoting.

FIG. 10 is a flow chart illustrating one embodiment of a method for insurance quoting.

### DETAILED DESCRIPTION

Various features and advantageous details are explained more fully with reference to the nonlimiting embodiments that are illustrated in the accompanying drawings and detailed in the following description. Descriptions of well known processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those having ordinary skill in the art from this disclosure.

In the following description, numerous specific details are provided, such as examples of programming, software modules, user selections, network transactions, database queries, database structures, hardware modules, hardware circuits, hardware chips, etc., to provide a thorough understanding of disclosed embodiments. One of ordinary skill in the art will recognize, however, that embodiments of the invention may be practiced without one or more of the specific details, or with other methods, components, materials, and so forth. In other instances, well-known structures, materials, or operations are not shown or described in detail to avoid obscuring aspects of the invention.

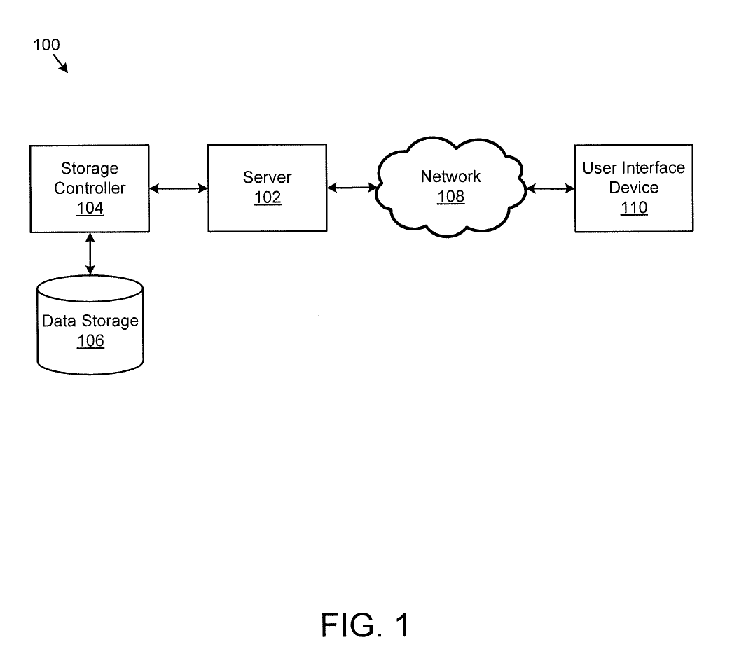

FIG. 1 illustrates one embodiment of a system 100 for insurance quoting. The system 100 may include a server 102, a data storage device 106, a network 108, and a user interface device 110. The system 100 may include a storage controller 104, or storage server configured to manage data communications between the data storage device 106, and the server 102 or other components in communication with the network 108. In an alternative embodiment, the storage controller 104 may be coupled to the network 108. In a general embodiment, the system 100 may allow a user to generate one or more images by the user interface device 110, where the images include identification information such as, for example, name, date of birth, mailing address, driver's license number, license plate of a vehicle, state identification number, and/or social security number. The images may be sent to the server 102 by network 108. The server 102 may extract the identification information contained in the images, generate an insurance quote based on the identification information, and send the generated insurance quote to the user interface device 110 by the network 108. The insurance quote may be a quote for an auto insurance, a home insurance, a flood insurance, a health insurance, a life insurance, a dental insurance, or the like.

The user interface device 110 is referred to broadly and is intended to encompass at least a suitable processor-based device such as a mobile communication device, a desktop computer, a laptop computer, a Personal Digital Assistant (PDA) or the like. In one embodiment, the user interface 110 may be a portable device with a camera, such as a mobile phone, a tablet, a camera, a camcorder, a gaming device, or the like. In a further embodiment, the user interface device 110 may generate images, edit the images and/or send the images to the server 102 though the network 108. In yet a further embodiment, the user interface device 110 may access the Internet to access a web application or web service hosted by the server 102 and provide a user interface for enabling a user to enter or receive information. For example, the user may receive an insurance quote from the server, or enter information in addition to images to obtain an insurance quote.

The network 108 may facilitate communications of data between the server 102 and the user interface device 110. The network 108 may include any type of communications network including, but not limited to, a wireless communication link, a direct PC to PC connection, a local area network (LAN), a wide area network (WAN), a modem to modem connection, the Internet, a combination of the above, or any other communications network now known or later developed within the networking arts which permits two or more computers to communicate with another.

In one embodiment, the server 102 may be configured to receive one or more images from a user, where the images contain identification information, to extract the identification from the received images, to generate an insurance quote based on the identification information, and send one or more generated insurance quotes to the user. The server 102 may also be configured to allow the user interface device 110 to download one or more programs, where the programs may allow the user to take one or more images containing identification information, send the images to the server 102, and receive one or more insurance quotes from the server. Additionally, the server 102 may access data stored in the data storage device 106 via a Storage Area Network (SAN) connection, a LAN, a data bus, or the like.

The data storage device 106 may include a hard disk, including hard disks arranged in an Redundant Array of Independent Disks (RAID) array, a tape storage drive comprising a magnetic tape data storage device, an optical storage device, or the like. In one embodiment, the data storage device 106 may store insurance underwriting information, such as insurance claims data, consumer data, or the like. For example, the data storage device 106 may store information about members of a household, list of vehicles that the members own and primary drivers of the drivers, accident history of the drivers and/or the vehicles, prior coverage information from previous insurance carriers for each vehicle, information about the dwelling (home), any losses associated with the dwelling (home), or the like. The data may be arranged in a database and accessible through Structured Query Language (SQL) queries, or other data base query languages or operations.

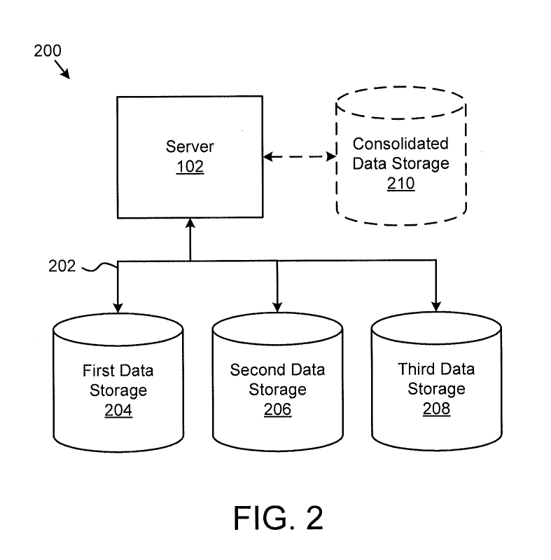

FIG. 2 illustrates one embodiment of a data management system 200 configured to store and manage data for insurance quoting. In one embodiment, the system 200 may include a server 102. The server 102 may be coupled to a data-bus 202. In one embodiment, the system 200 may also include a first data storage device 204, a second data storage device 206 and/or a third data storage device 208. In other embodiments, the system 200 may include additional data storage devices (not shown). In such an embodiment, each data storage device 204-208 may host a separate database of insurance rates for various situations, images received from users, and information extracted from the images, or the like. For example, for auto insurance applications, the data storage devices 204-208 may store various information about vehicles and/or the involved user, such as how many vehicles the user owns, the make, year and mileage of each of the vehicles, what kind of auto insurance is currently associated with each of the vehicles, whether the vehicle was involved in any accident, whether the driver's license of the user is under suspension, credit status of the user, or the like. Also, the generated insurance quotes may be saved in the data storage devices 204-208 for retrieval later by an insurance agent or by a customer, where the insurance quotes may be modified and an application for a new quote based on the modification may be submitted. The data storage devices 204-208 may also store one or more programs which are configured to, when executed, calculate an insurance rate based on various information related to insurance quotes, such as those described above. The storage devices 204-208 may be arranged in a RAID configuration for storing redundant copies of the database or databases through either synchronous or asynchronous redundancy updates.

In one embodiment, the server 102 may submit a query to selected data storage devices 204-208 to collect a consolidated set of data elements associated with an individual or group of individuals. The server 102 may store the consolidated data set in a consolidated data storage device 210. In such an embodiment, the server 102 may refer back to the consolidated data storage device 210 to obtain a set of data elements associated with a specified individual. Alternatively, the server 102 may query each of the data storage devices 204-208 independently or in a distributed query to obtain the set of data elements associated with a specified individual. In another alternative embodiment, multiple databases may be stored on a single consolidated data storage device 210.

In various embodiments, the server 102 may communicate with the data storage devices 204-210 over the data-bus 202. The data-bus 202 may comprise a SAN, a LAN, a wireless connection, or the like. The communication infrastructure may include Ethernet, Fibre-Chanel Arbitrated Loop (FC-AL), Small Computer System Interface (SCSI), and/or other similar data communication schemes associated with data storage and communication. For example, the server 102 may communicate indirectly with the data storage devices 204-210; the server first communicating with a storage server or storage controller 106.

The server 102 may host a software application configured for insurance quoting. The software application may further include modules for interfacing with the data storage devices 204-210, interfacing a network 108, interfacing with a user, and the like. In one embodiment, the server 102 may host an engine, application plug-in, or application programming interface (API). In another embodiment, the server 102 may host a web service or web accessible software application.

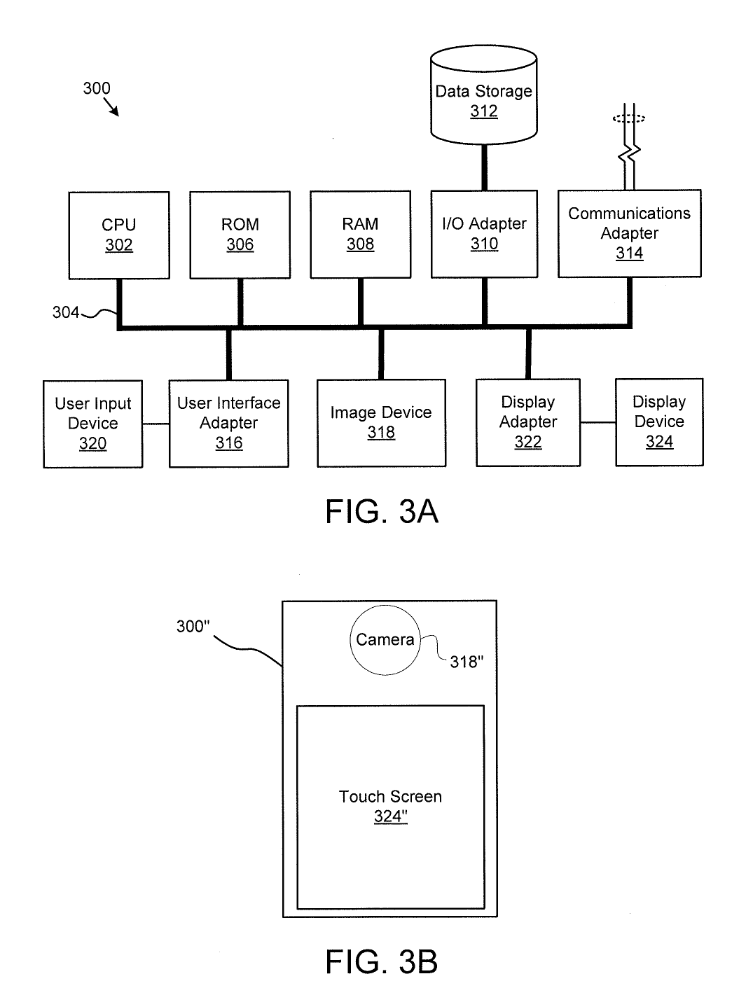

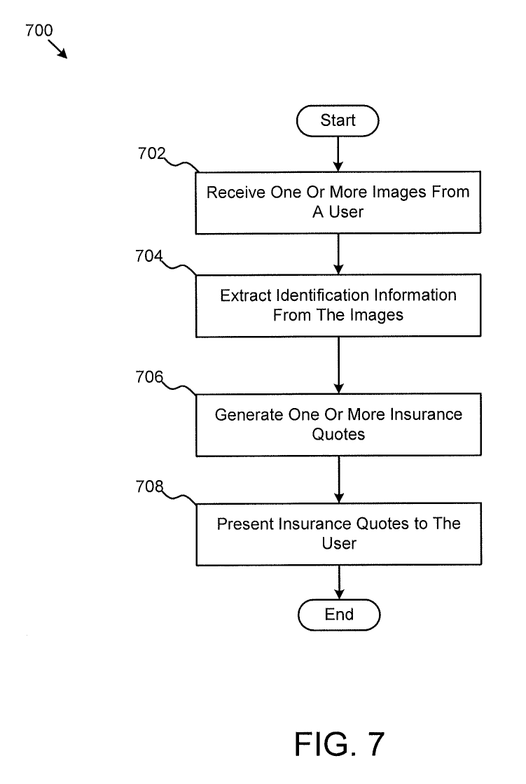

FIG. 3A illustrates a system according to certain embodiments of the user interface device 110. The central processing unit (CPU) 302 is coupled to the system bus 304. The CPU 302 may be a general purpose CPU or microprocessor. The present embodiments are not restricted by the architecture of the CPU 302, so long as the CPU 302 supports the modules and operations as described herein. The CPU 302 may execute various logical instructions according to disclosed embodiments. For example, the CPU 302 may execute machine-level instructions according to the exemplary operations described below with reference to FIGS. 7-10.

The device 110 may include Random Access Memory (RAM) 308, which may be SRAM, DRAM, SDRAM, or the like. The device 110 may utilize RAM 308 to store the various data structures used by a software application configured for insurance quoting. The device 110 may also include Read Only Memory (ROM) 306 which may be PROM, EPROM, EEPROM, optical storage, or the like. The ROM may store configuration information for booting the computer system 300. The RAM 308 and the ROM 306 hold user and system data.

The device 110 includes an image device 318, which allows a user to capture/create images and/or edit images. In one embodiment, the image device 318 may be a camera, e.g., a camera embedded into a mobile phone. The image device 318 may also be a scanner. In one embodiment, the image device 318 may be a touch screen which allows a user to draw or write on the screen, where the result image may then be stored or sent to a server. The images may be stored, under the control of the CPU 302, to the data storage 312, and/or sent to the server 102 through the communication adapter 314. The device 110 may also include an input/output (I/O) adapter 310, a communications adapter 314, a user interface adapter 316, and a display adapter 322. The I/O adapter 310 and/or user the interface adapter 316 may, in certain embodiments, enable a user to interact with the device 110 for information input, such as entering additional information besides images and/or contacting an insurance agent. In a further embodiment, the display adapter 322 may display a graphical user interface associated with a software or web-based application for insurance quoting.

The I/O adapter 310 may connect to one or more storage devices 312, such as one or more of a hard drive, a SIM card, a flash drive, to the system 300. The communications adapter 314 may be adapted to couple the system to the network 108, which may be one or more of a wireless link, a LAN and/or WAN, and/or the Internet. In one embodiment, the communications adapter 314 may include one or more transmitting antennas and receiving antennas, which may be configured to transmit and receive wireless signals. The user interface adapter 316 couples user input devices 320, such as a keyboard, a touch screen, and/or a pointing device, to the system 300. The display adapter 322 may be driven by the CPU 302 to control the display on the display device 324.

In one embodiment, the system may be configured to generate and/or edit one or more images by the image device 318. The system may compress the images with the control of CPU 302 and send the images, by communications adapter 314, to server 102. In one embodiment, the system may also receive one or more insurance quotes from the server 102, through the communications adapter 314, and display the insurance quote and other received information to the user by the display device 324.

Disclosed embodiments are not limited to the architecture of the system. Rather the disclosed system is provided as an example of one type of device that may be adapted to perform functions of a user interface device 110. For example, any suitable processor-based device may be utilized including mobile phones, tablets, cameras, camcorders, gaming devices, personal data assistants (PDAs), or the like. Moreover, the present embodiments may be implemented on application specific integrated circuits (ASIC) or very large scale integrated (VLSI) circuits. In fact, one of ordinary skill in the art may utilize any number of suitable structures capable of executing logical operations according to the disclosed embodiments. For example, FIG. 3B illustrates a front face of a mobile phone 300″ that may be used as a user interface device 110 in accordance with one embodiment of the system 300, where the front face of the mobile phone 300″ shows a camera 318″ for taking photos and a touch screen 324″ for both information input and display. The mobile phone 300″ may have a front camera or a rear camera, or both. Images may be captured by either one of the cameras or both cameras.

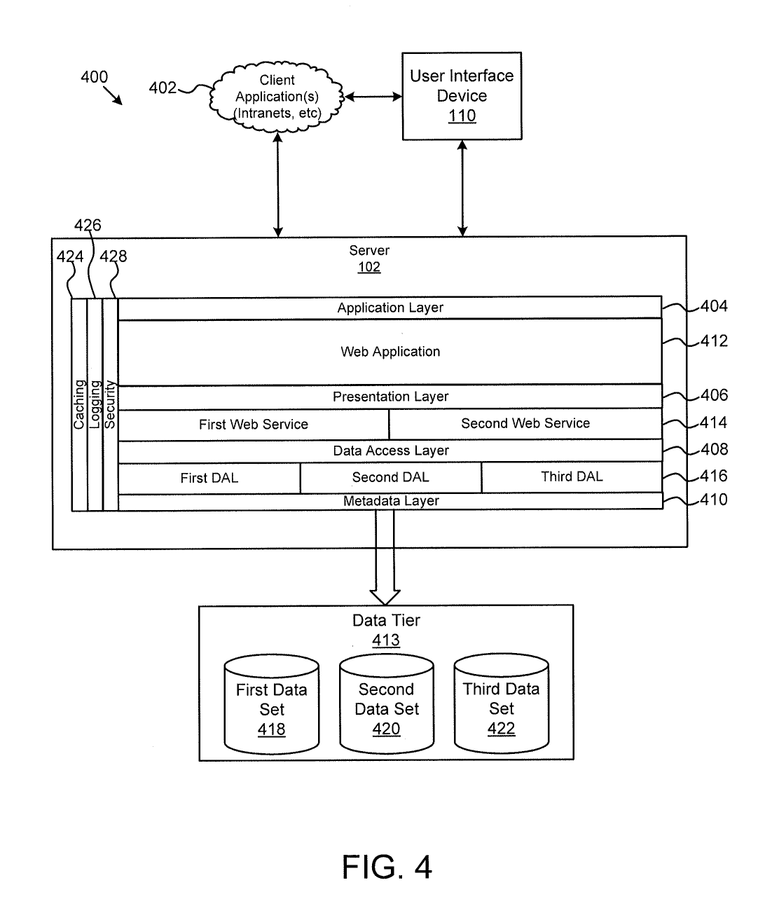

FIG. 4 illustrates one embodiment of a network-based system 400 for insurance quoting. In one embodiment, the network-based system 400 includes a server 102. Additionally, the network-based system 400 may include a user interface device 110. In still a further embodiment, the network-based system 400 may include one or more network-based client applications 402 configured to be operated over a network 108 including a wireless network, an intranet, the Internet, or the like. In still another embodiment, the network-based system 400 may include one or more data storage devices 106.

The network-based system 400 may include components or devices configured to operate in various network layers. For example, the server 102 may include modules configured to work within an application layer 404, a presentation layer 406, a data access layer 408 and a metadata layer 410. In a further embodiment, the server 102 may access one or more data sets 418-422 that comprise a data layer or data tier 413. For example, a first data set 418, a second data set 420 and a third data set 422 may comprise a data tier 413 that is stored on one or more data storage devices 204-208.

One or more web applications 412 may operate in the application layer 404. For example, a user may interact with the web application 412 though one or more I/O interfaces 318, 320 configured to interface with the web application 412 through an I/O adapter 310 that operates on the application layer. In one embodiment, a web application 412 may be provided for insurance quoting that includes software modules configured to perform the steps of receiving images from a remote user where the images contain identification information, extracting identification information from the images, generating an insurance quote based on the extracted identification information and sending the insurance quote to the user.

In a further embodiment, the server 102 may include components, devices, hardware modules, or software modules configured to operate in the presentation layer 406 to support one or more web services 414. For example, a web application 412 may access or provide access to a web service 414 to perform one or more web-based functions for web application 412. In one embodiment, web application 412 may operate on a first server 102 and access one or more web services 414 hosted on a second server (not shown) during operation.

In one embodiment, a web application 412 or a web service 414 may access one or more of the data sets 418-422 through the data access layer 408. In certain embodiments, the data access layer 408 may be divided into one or more independent data access layers 416 for accessing individual data sets 418-422 in the data tier 413. These individual data access layers 416 may be referred to as data sockets or adapters. The data access layers 416 may utilize metadata from the metadata layer 410 to provide the web application 412 or the web service 414 with specific access to the data set 412.

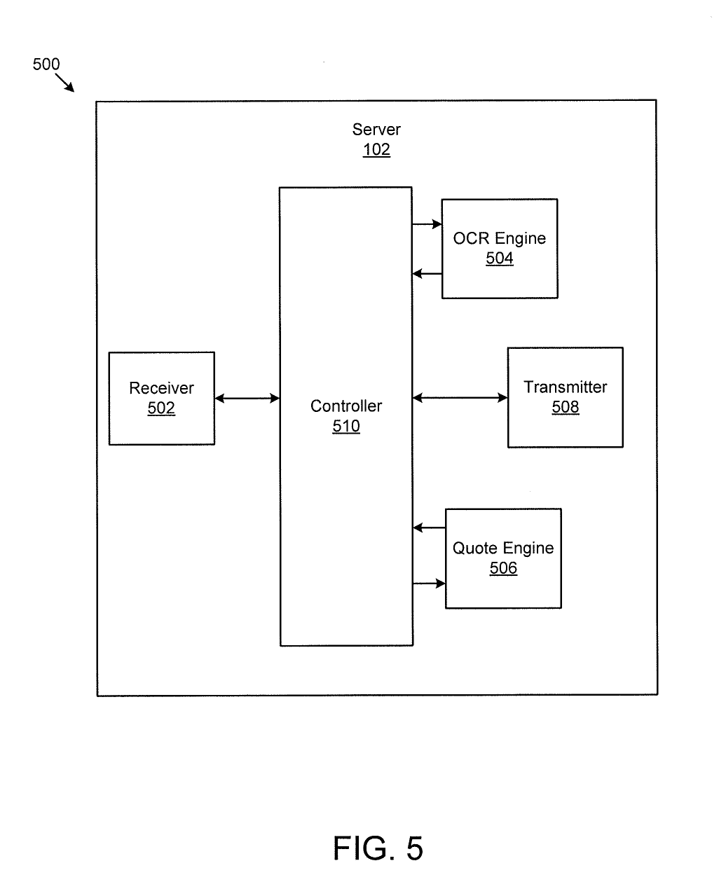

FIG. 5 illustrates a system 500 according to certain embodiments of the server 102 for insurance quoting. In one embodiment, the system 500 may include a receiver 502, a controller 510, an OCR engine 504, and quote engine 506 and a transmitter 508. The receiver 502 may be configured to receive images and other information from a remote user. The received images may be transferred, controlled by the controller 510, to the OCR engine 504. The OCR engine 504 may extract identification information, required for an insurance quote, from the images, and send the extracted identification information back to the controller 510. The controller 510 may forward the extracted identification information to the quote engine 506. Base on the identification information, the quote engine 506 may generate an insurance quote and send the generated insurance quote back to the controller 510. In one embodiment, the quote engine may access a data storage device, such as the data storage 106 described in FIG. 1, for insurance related data. Afterwards, the controller 510 may forward the insurance quote to the transmitter 508, and the transmitter 508 may transmit the insurance quote to the remote user.

For example, if the received images include a driver's license, the identification information extracted by the OCR engine 504 may include name, date of birth, address with zip code and/or driver's license number of the driver. If the user requests an auto insurance quote, the quote engine 506 may access information from the data storage 106, or by calling an external web service, such as a prior insurance carrier service. The access information may include various information about the driver displayed on the driver's license, such as how many vehicles the driver owns, the make, year and mileage of each of the vehicles, what kind of auto insurance is currently associated with each of the vehicles, whether the vehicle was involved in any accident, whether the driver's license is under suspension, credit status of the driver, prior insurance coverage, limits on the driver, or the like. The quote engine may also access one or more programs from the data storage 106, which are configured to, when executed, calculate an insurance rate based on various information related to insurance quote, such as those described above. If there is more than one vehicle associated with the driver, an auto insurance for each of the vehicles may be generated and sent to the user. Alternatively, the user may be instructed to select which vehicle(s) he/she wants to quote.

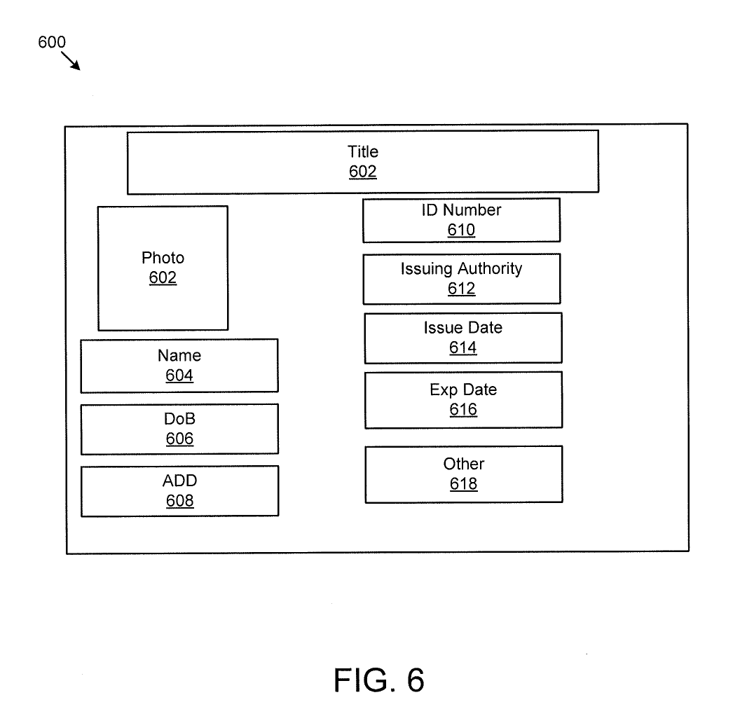

FIG. 6 illustrates an identification card 600 useable for insurance quoting. The identification card 600 may be a driver's license, a state ID, a social security card, or the like. In one embodiment, the identification card 600 may include a title 602, a photo 602, a name 604, a date of birth 606 and an address 608 including a zip code. The identification card 600 may further include an ID number 610, an issuing authority 612, an issue date 614, a expiration date 616 and/or other information that can help to identify the holder of the identification card 600.

The schematic flow chart diagrams that follow are generally set forth as logical flow chart diagrams. As such, the depicted order and labeled steps are indicative of one embodiment of the present disclosure. Other steps and methods may be employed that are equivalent in function, logic, or effect to one or more steps, or portions thereof, of the illustrated method. Additionally, the format and symbols employed are provided to explain logical steps and should be understood as not limiting the scope of an invention. Although various arrow types and line types may be employed in the flow chart diagrams, they should be understood as not limiting the scope of the corresponding method. Indeed, some arrows or other connectors may be used to indicate only the logical flow of the method. For instance, an arrow may indicate a waiting or monitoring period of unspecified duration between enumerated steps. Additionally, the order in which a particular method occurs may or may not strictly adhere to the order of the corresponding steps shown.

FIG. 7 illustrates one embodiment of a method 700 for insurance quoting. In one embodiment, the method 700 starts with receiving 702 one or more images from a remote user. In one embodiment, at least one of the one or more images may be generated by a portable electronic device, such as a mobile phone, a tablet, a camera, a camcorder, a gaming device, or the like. In one embodiment, the images may be generated by taking one or more photos using a portable electronic device. The images may also be generated by a user drawing and/or writing on a touch screen of a portable electronic device. In one embodiment, at least one of the one or more images may be related to a driver's license. The images may also related to a state ID card, a social security card, or the like. The method 700 may also include extracting 704 identification information from the received one or more images. In one embodiment, the extracted identification information may include name, date of birth, address with zip code, and/or ID number such as a driver's license number, VIN number, or social security number. The method may also include the step of presenting the extracted information to the remote user to permit verification of the information.

In one embodiment, the method 700 may further include generating 706 one or more insurance quotes based on the identification information extracted from received images. The insurance quote generated by step 706 may be a quote for an auto insurance, a home insurance, a flood insurance, a health insurance, a life insurance, a dental insurance, or the like. The method 700 may also include presenting 708 the generated insurance quotes to the user. In one embodiment, the user may directly purchase the insurance quote presented to him or her by, e.g. navigating to a web application hosted by server 102.

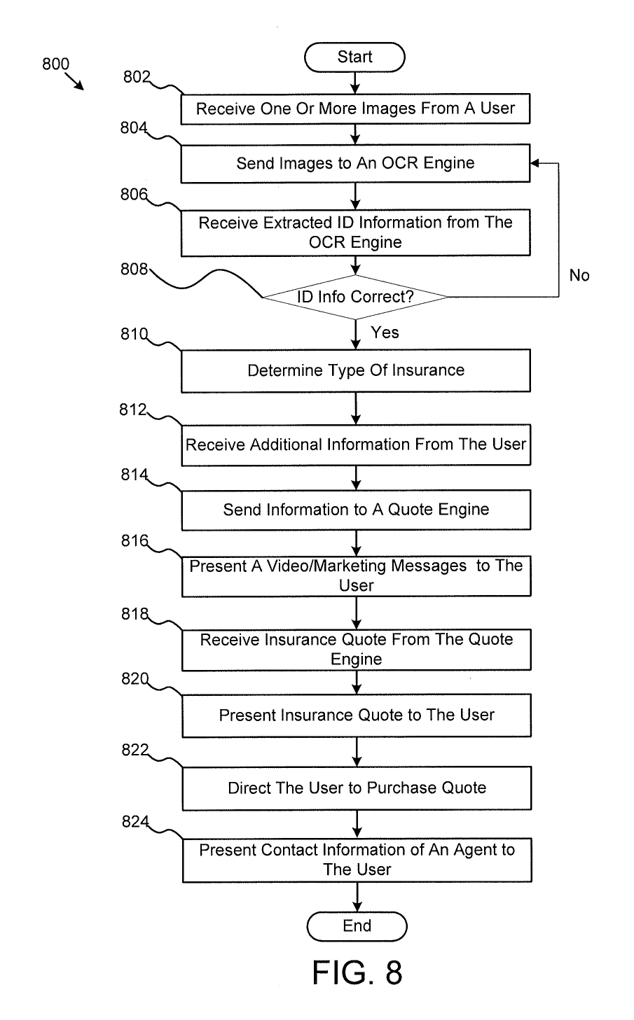

FIG. 8 illustrates one embodiment of a method 800 for insurance quoting. In one embodiment, the method 800 may include receiving 802 one or more images from a user. The images may be generated by a portable device described above, and may be related to an identity card as described above. The method 800 may further include sending 804 the received images to an OCR engine. The OCR engine may extract identification information, such as those described in FIG. 7, and send the extracted identification back. The method 800 may then receive 806 extracted identification information from the OCR engine.

The method 800 may determine 808 whether the extracted identification information is correct. In one embodiment, determining 808 whether the extracted identification information is correct may include sending the extracted identification information to the user and instruct the user to confirm whether the extracted identification information is correct. For example, the method 800 may send the extracted identification information to the user, where the information is displayed to the user, and the user can click on a “YES” or “NO” button on a display of the user interface device 110 to confirm whether extracted identification information is correct. If the extracted identification information is not correct, the method 800 may go back to step 804 and request the OCR engine to extract identification information again.

If the extracted identification information is correct, the method 800 may proceed to determine 810 a type of the insurance that the user request. In one embodiment, determining 810 a type of insurance may include instructing the user to select from a list of insurance types and/or entering an insurance type. The method 800 may further include receiving additional information from the user. For example, if images of a driver's license are received from the user, and the user requests for an auto insurance for a new car, the method 800 may receive 812 additional information such as VIN, year and/or make of a vehicle, by instructing the user to enter additional information. In a case where the method 800 identifies, e.g., by searching a database, that there are already one or more vehicles associated with the owner of the driver's license, the method 800 may receive 812 additional information such as whether the user requests a quote for a new vehicle, or which vehicle(s) already associated with the driver.

Afterwards, the method 800 may send 814 all gathered information to a quote engine, where the quote engine may generate a rate for the requested insurance. While waiting for an insurance quote from the quote engine, the method 800 may present 816 a video and/or marketing messages to the user displayed on, e.g. the user interface device 110. After the method 800 receives 818 an insurance quote from the quote engine, the method 800 may present 820 the insurance quote to the user. In one embodiment, the method 800 may direct 822 the user to purchase the insurance quote by, e.g. directing the user to a web application hosted by a server. The method 800 may also present 824 contact information of an agent to the user, where the user may contact the agent to purchase the insurance quote presented to him/her, or request for another insurance quote. The contact information of the agent may include a physical address, a phone number, an email address, an instant messaging account number to or a web site address. In addition, the contact information may include a hot link enabling the user to reach an agent using a single-click to call an agent, to send a text message to an agent or to access to an agent's website.

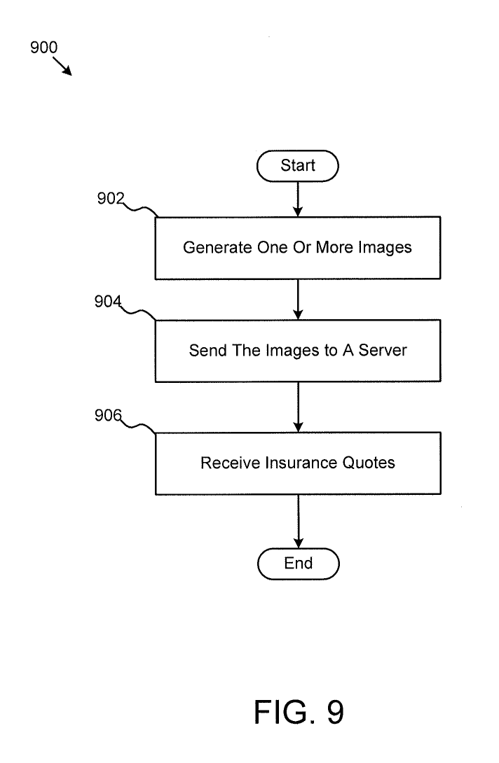

FIG. 9 illustrates one embodiment of a method 900 for insurance quoting. In one embodiment, the method 900 starts with generating 902 one or more images. The images may be generated by a portable electronic device such as a mobile phone, a tablet, a camera, a camcorder, a gaming device or the like. In one embodiment, the images may be generated by taking one or more photos using a portable electronic device. The images may also be generated by a user drawing and/or writing on a touch screen of a portable electronic device. In one embodiment, at least one of the one or more images may be related to a driver's license. The images may also related to a state ID card, a social security card, or the like. The method 900 may also include sending 904 the generated images to a server through, e.g. a wireless link, a LAN, a WAN, an intranet, Internet, or the like.

In one embodiment, the method 900 may further include receiving 906 one or more insurance quotes from a server. The insurance quote may be a quote for an auto insurance, a home insurance, a flood insurance, a life insurance, a health insurance, a dental insurance, or the like. The received insurance quote may be presented to the user where the user may then purchase the insurance quote by, e.g. navigating to a web application hosted by a server.

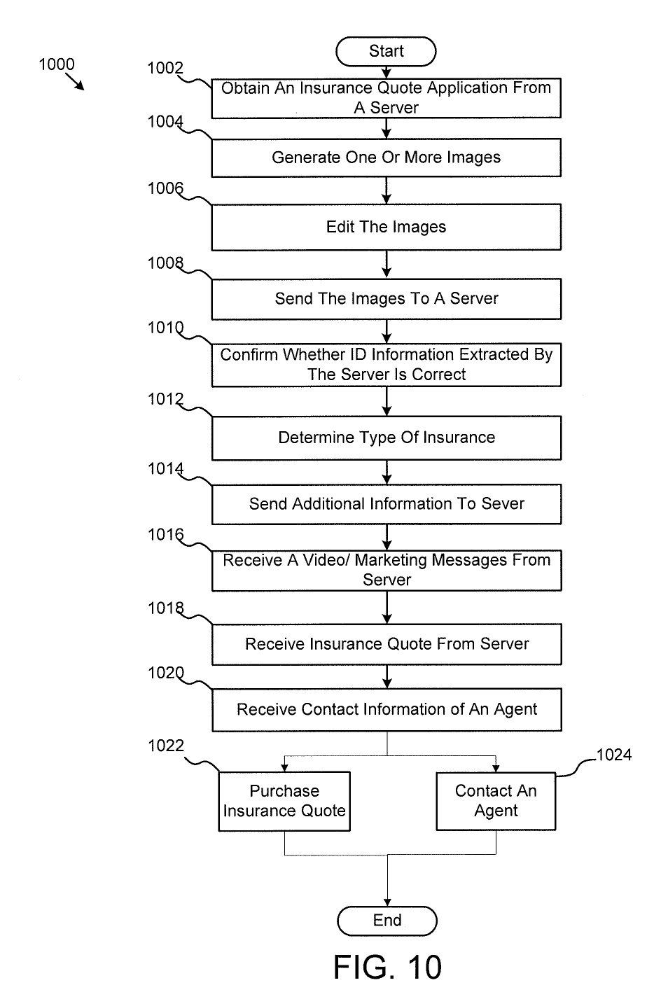

FIG. 10 illustrates one embodiment of a method 1000 for insurance quoting. In one embodiment, the method 1000 starts with obtaining 1002 an insurance quote application from a server, where the method 1000 may download an insurance quote application from a server, and install the insurance quote application on a portable electronic device. The method 1000 may generate 1004 one or more images, where the images include identification information. In one embodiment, the images may be captured by a device such as a camera or a scanner included in a portable electronic device. Alternatively, the image may be generated by a user drawing and/or writing on a input device such as a touch screen on a portable electronic device.

The method 1000 may further include editing 1006 the one or more images, where editing 1006 may include actions such as trimming, highlighting, rotating, zooming, or the like. The method 1000 may then send 1008 the images to a server by, e.g. a wireless link, a LAN, a WAN, Internet, or the like. In one embodiment, the method 1000 may also include confirming 1010 whether the identification information extracted by the server is correct. Confirming 1010 whether the identification information extracted by the server is correct may be realized by a user clicking on a “YES” or “NO” button on a display of a user interface device, such as a mobile phone.

The method 1000 may further include determining 1012 a type of insurance. For example, the type of insurance may be determined by a user selecting an insurance type from a list of insurances, or entering a desired insurance type. The method 1000 may also include sending 1014 additional information to a server. For example, if images of a driver's license are sent to an insurance quoting server, and the user requests for an auto insurance for a new car, the method 1000 may send 1014 additional information such as VIN, year and/or make of a vehicle, by user entering additional information. In a case where one or more vehicles associated with the owner of the driver's license are presented to the user, the method 1000 may send 1014 additional information such as whether the user requests a quote for a new vehicle, or which vehicle(s) already associated with the driver. While waiting for an insurance quote, the method 1000 may receive 1016 a video and/or marketing messages from the server.

In one embodiment, the method 1000 may include receiving 1018 an insurance quote from the server. The method 1000 may also include receiving 1020 contact information of an agent from the server. The contact information of the agent may include a physical address, a phone number, an email address, an instant messaging account number to or a web site address. In addition, the contact information may include a hot link enabling the user to reach an agent using a single-click to call an agent, to send a text message to an agent or to access to an agent's website. Afterwards, the method 1000 may either purchase 1022 the received insurance quote, e.g. by navigating to a web application hosted by the sever. The method 1000 may also include contacting 1024 an agent to either accept the received insurance quote or to request another insurance quote. Contacting an agent may include use of information provided to the user in step 1020.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

1. A method comprising:
receiving from a user one or more images of a driver's license and generated by a portable electronic device;
extracting identification information from the one or more images of the driver's license;
obtaining, from a data storage device, information associated with the extracted identification information;
generating, by an automated programmed computer, an insurance quote based, at least in part, on the extracted driver's license identification information; and
presenting the insurance quote to the user through the portable electronic device.

2. The method of claim 1, the identification information comprising a driver's license number.

3. The method of claim 1, the identification information comprising a name and a birth date of a driver.

4. The method of claim 1, the identification information comprising an address and zip code of a residence of a driver.

5. The method of claim 1, further comprising:
receiving from the user one or more images of a vehicle license plate and generated by the portable electronic device;
extracting vehicle license plate identification information from the one or more images of the vehicle license plate; and
the generating step further comprising, generating the insurance quote based, at least in part, on the extracted vehicle license plate identification information.

6. The method of claim 1, further comprising:
receiving from the user a vehicle identification number (VIN) of a vehicle; and
the generating step further comprising, generating the insurance quote based, at least in part, on the VIN.

7. The method of claim 1, the insurance quote being an auto insurance quote.

8. The method of claim 1, the insurance quote being a life insurance quote.

9. The method of claim 1, the insurance quote being a home insurance quote.

10. The method of claim 1, the insurance quote being a flood insurance quote.

11. The method of claim 1, further comprising, presenting contact information of an agent to the user.

12. The method of claim 11, the contact information being selected from the group consisting of a physical address, a phone number, an email address, an instant messaging account number, and a web site address.

13. The method of claim 1, further comprising, after the extracting step:
presenting the extracted driver's license identification information to the user through the portable electronic device; and
receiving from the user a verification of accuracy of the extracted driver's license identification information.

14. A method comprising:
using a portable electronic device to generate one or more images of a driver's license;
sending the one or more images via the portable electronic device to a server, the server configured to:
extract identification information from the one or more images; and
obtain, from a data storage device, information associated with the extracted identification information;
generate, by an automated programmed computer, an insurance quote based, at least in part, on the extracted identification information; and
receiving the insurance quote via the portable electronic device.

15. A portable electronic device comprising:
a mechanism for generating one or more images including identification information;
a transmitter to transmit the one or more images to a server, the server being configured to extract the identification information from the one or more images; and to generate an insurance quote based, at least in part, on the extracted identification information;
a receiver to receive the insurance quote; and
a mechanism for presenting the insurance quote to a user.

16. A computer executable non-transitory tangible storage medium storing one or more programs, the one or more programs configured to:
receive from a user one or more images related to a driver's license and generated by a portable electronic device;
extract identification information from the one or more images;
obtain, from a data storage device, information associated with the extracted identification information;
generate an insurance quote based, at least in part, on the extracted identification information; and
present the insurance quote to the user via the portable electronic device.

17. A computer executable non-transitory tangible storage medium storing one or more programs, the one or more programs configured to cause a portable electronic device to:
generate one or more images including identification information;
send the one or more images to a server, the server configured to extract identification information from the one or more images; and to generate an insurance quote based, at least in part, on the extracted identification information;
receive the insurance quote; and
present the insurance quote to a user via the portable electronic device.

18. A system comprising:
a receiver configured to receive one or more images from a user, the one or more images including identification information;
a server in data communication with the receiver suitably configured to:
extract the identification information from the one or more images;
obtain, from a data storage device, information associated with the extracted identification information;
generate an insurance quote based, at least in part, on the extracted identification information; and
a transmitter in data communication with the server suitably configured to transmit the insurance quote to the user.

19. A portable electronic device comprising:
means for generating one or more images using a portable electronic device, the one or more images including identification information;
means for transmitting the one or more images to a server, the server configured to extract the identification information from the one or more images;
means for presenting the identification information to a user for verification;
means for obtaining, from a data storage device, information associated with the extracted identification information;
means for generating an insurance quote based, at least in part, on the extracted identification information;
means for receiving the insurance quote; and
means for presenting the insurance quote to the user via the portable electronic device.

20. An apparatus comprising:
means for receiving one or more images from a user, at least one of the one or more images being related to a driver's license and generated by a portable electronic device;
means for extracting the identification information from the one or more images;
means for obtaining, from a data storage device, information associated with the identification information;
means for generating an insurance quote based, at least in part, on the extracted identification information; and
means for transmitting the insurance quote to the user.
